(19) United States
(12) Patent Application Publication
(10) Pub. No.: US 2017/0124641 A9
(43) Pub. Date: May 4, 2017

(54) METHOD AND SYSTEM FOR ACCOUNT HOLDERS TO MAKE, TRACK AND CONTROL VIRTUAL CREDIT CARD NUMBERS USING AN ELECTRONIC DEVICE

(71) Applicant: CSI ENTERPRISES, INC, Bonita Springs, FL (US)

(72) Inventors: Keith J. Stone, Bonita Springs, FL (US); David R. Disque, Naples, FL (US); Andrew Dunahay, Cape Coral, FL (US); Jason Kolbenheyer, Pawcatuck, CT (US)

(21) Appl. No.: 13/714,653

(22) Filed: Dec. 14, 2012

Related U.S. Application Data
(63) Continuation-in-part of application No. 13/252,843, filed on Oct. 4, 2011.

(51) Int. Cl. G06Q 40/02

(52) U.S. Cl. CPC G06Q 40/02

(57) ABSTRACT

A method and system that allows an account holder to create secure single and multi-use virtual credit account numbers from electronic devices, such as smart phones, tablets, computers and so forth. In addition, the method and system allows non-editable virtual credit card images to be created in another name from an administrator's account, which is perfect for employer/employee card creation, and electronically transmitted to an intended recipient. Secure virtual credit account numbers may be sent via email as a card image or SMS text message. An account holder or appointed administrator may establish restrictions on usage of a recipient's virtual credit card. The method and system also includes a pay system for processing batch payments for vendors by uploading payment files and issuing virtual credit cards to vendors with outstanding invoices.

### CROSS-REFERENCE TO RELATED APPLICATIONS

This application is a continuation-in-part of application Ser. No. 13/252,843, filed on Oct. 4, 2011, which is currently pending. The patent application identified above is incorporated herein by reference in its entirety to provide continuity of disclosure.

### FIELD OF THE INVENTION

This invention relates to day to day financial transactions made by account holders, such as business owners, employees and ordinary individuals and more particularly to a method and system that allows an account holder to create secure single and multi-use virtual credit cards from an electronic device and securely transmit that information to a vendor for payment of an amount due or to a third party, such as an employee for use by the employee to charge business expenses.

### BACKGROUND OF THE INVENTION

Credit account holders, such as businesses, conduct financial transactions using credit cards every day. For example, businesses may conduct financial transactions that include vendor payments, travel arrangements, office supplies, car rentals, hotel reservations and so forth. Business owners are concerned with tracking vendor payments made using credit cards due to possible overcharges, skimming, fraud and/or theft that may occur. In addition, business owners are concerned about employees' use of company credit cards for the same reasons. However, business owners often find out about occurrences of overcharges, skimming, fraud and/or theft after it has already happened. The same is true for ordinary individuals using personal credit accounts.

Therefore, a need exists for a method and system for account holders to prevent occurrences of overcharges, skimming, fraud and/or theft prior to these actions occurring by allowing account holders to make payments to vendors using secure single and multi-use virtual credit cards and provide third party recipients, such as employees or a child who needs a loan, with virtual credit cards from an electronic device, such as a smart phone, tablet, computer and so forth, while being able to monitor and restrict usage of the virtual credit cards at any time from the same or other device.

The relevant prior art includes the following references:

| Patent No. | | Issue/Publication |
|---|---|---|
| (U.S. Patent References) | Inventor | Date |
| 2011/0137748 | Baher | Jun. 09, 2011 |
| 2011/0153437 | Archer et al. | Jun. 23, 2011 |
| 2011/0145044 | Nelson et al. | Jun. 16, 2011 |
| 2011/0137748 | Baher | Jun. 09, 2011 |
| 7,859,529 | Walker et al. | Dec. 14, 2010 |
| 7,844,550 | Walker et al. | Nov. 30, 2010 |
| 2010/0299259 | Walker et al. | Nov. 25, 2010 |
| 2010/0288834 | Tichelaer et al. | Nov. 18, 2010 |
| 7,822,666 | Bursch | Oct. 26, 2010 |
| 7,810,720 | Lovett | Oct. 12, 2010 |
| 2010/0088188 | Kumer et al. | Apr. 08, 2010 |
| 7,593,896 | Flitcroft et al. | Sep. 22, 2009 |
| 7,571,142 | Flitcroft et al. | Aug. 04, 2009 |
| 7,568,631 | Gibbs et al. | Aug. 04, 2009 |
| 7,567,934 | Flitcroft et al. | Jul. 28, 2009 |
| 2009/0006254 | Mumm et al. | Jan. 01, 2009 |
| 2008/0033878 | Krikorian et al. | Feb. 07, 2008 |
| 7,236,957 | Crosson Smith | Jun. 26, 2007 |
| 7,177,835 | Walker et al. | Feb. 13, 2007 |
| 7,136,835 | Flitcroft et al. | Nov. 14, 2006 |
| 2006/0248009 | Hicks et al. | Nov. 02, 2006 |
| 2005/0177504 | Crosson Smith | Aug. 11, 2005 |
| 2004/0133507 | Barbour | Jul. 08, 2004 |
| 2002/0046341 | Kazaks et al. | Apr. 18, 2002 |
| 2003/0105709 | Orlando | Dec. 03, 2001 |
| 2001/0047335 | Arndt et al. | Nov. 29, 2001 |
| 6,202,155 | Tushie et al. | Mar. 13, 2001 |
| 6,613,771 | Walker et al. | Dec. 19, 2000 |
| 5,883,810 | Franklin et al. | Mar. 16, 1999 |

### NON-PATENT REFERENCES

http://www.tchek.com/offerings/corporate-and-commercial/virtual-card/http://www.
http://www.geardiary.com/2009/01/24/use-paypals-free-disposable-credit-card-number-to-manage-recurring-charges/
http://techland.time.com/2011/05/03/disposable-credit-card-numbers-can-protect-you-from-hacks/

### SUMMARY OF THE INVENTION

The primary object of the present invention is to provide a method and system for account holders to make, track and control virtual credit card numbers in which an account holder may create secure single and multi-use virtual credit cards using an electronic device, such as a smart phone, tablet, computer and so forth.

An additional object of the present invention is to provide a method and system for account holders to make, track and control virtual credit card numbers using an electronic device in which an account holder can create and use virtual credit cards to make payments to vendors.

A further object of the present invention is to provide a method and system for account holders to make, track and control virtual credit card numbers using an electronic device in which an account holder can create and send virtual credit cards to an employee for the employee to make one or more business transactions.

An additional object of the present invention is to provide a method and system for account holders to make, track and control virtual credit card numbers using an electronic device in which an account holder may create an instant virtual credit card using pre-stored account information.

A further object of the present invention is to provide a method and system for account holders to make, track and control virtual credit card numbers using an electronic device in which an account holder can mange and track the use of virtual credit cards at any time from an electronic device.

An additional object of the present invention is to provide a method and system for account holders to change restrictions on use for issued virtual credit cards and/or block existing virtual credit cards from further use at any time from an electronic device.

The present invention fulfills the above and other objects by providing a payment method that allows an account holder or user to create secure single and multi-use virtual credit cards from electronic devices, such as smart phones, tablets, computers and so forth. The method and system allows non-editable virtual credit card images to be created in another name from an administrator's account and then be electronically transmitted to an intended recipient. Secure virtual credit cards or credit card numbers may be sent via email as a card image or SMS text message. The method and system of the present invention also contains enhanced security features, including a personal identification number (“PIN”) prompting at setup and an option to create single and multi-use virtual credit cards for vendor payments all without storing sensitive credit card data on a mobile device's operating system or hardware. The method and system has custom control features which include purchase restrictions that may be set when a virtual credit card is created and then changed at any time by the account holder or administrator. For example, an account holder or appointed administrator may restrict an employee's virtual credit card for use at businesses having specific merchant category codes (“MCC”), such as an airline to ensure the employee only uses the virtual credit card to purchase an airline ticket. The account holder may change those restrictions or disable the virtual credit card from further use at any time from an electronic device, such as a smart phone, tablet, computer and so forth.

Virtual credit cards may also be assigned to specific accounts payable, purchase orders, invoice numbers and/or be customized with memo notes. Users may also copy and paste virtual credit card numbers within an Internet browser to complete an online purchase as well as view or block existing virtual credit cards from any further use at any time from any electronic device. In addition, virtual credit cards may be created and sent as payments, rewards, incentives, rebates, loyalty incentives to employees or customers and so forth.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a flow chart showing various users of the method and system of the present invention;

FIG. 2 is a flow chart showing steps for creating an account with a credit card issuer to be used in conjunction with the method and system of the present invention;

FIG. 3 is a flow chart showing steps for accessing an account holder's account via an electronic device using the method and system of the present invention;

FIG. 4 is a flow chart showing steps for creating a virtual credit card using the method and system of the present invention;

FIG. 5 is a flow chart showing steps for electronically transmitting a virtual credit card to a recipient using the method and system of the present invention;

FIG. 6 is a flow chart showing steps for managing existing virtual credit cards of an account using the method and system of the present invention;

FIG. 7 is a flow chart showing steps for managing various account settings using the method and system of the present invention;

FIG. 8 is a flow chart showing steps for creating an instant virtual credit card using the method and system of the present invention;

FIG. 9 is a flow chart showing steps for copying instant virtual credit card information into a payment screen to complete an online purchase using the method and system of the present invention;

FIG. 10 is an example of a computer environment, in which the method and system of the present invention operates;

FIG. 11 is a front view of an electronic device displaying an account setup screen of the present invention;

FIG. 12 is a front view of an electronic device displaying a user login screen requiring a PIN of the present invention;

FIG. 13 is a front view of an electronic device displaying a main screen having the options of creating an instant virtual credit card, a virtual credit card, viewing existing virtual credit cards or viewing account settings of the present invention;

FIG. 14 is a front view of an electronic device displaying options and step for creating a virtual credit card of the present invention;

FIG. 15 is a front view of an electronic device displaying advanced options and step for creating a virtual credit card of the present invention;

FIG. 16 is a front view of an electronic device displaying an option to limit the number of transactions that may be performed using a virtual credit card of the present invention;

FIG. 17 is a front view of an electronic device displaying an option to limit the merchant categories where a virtual credit card of the present invention may be used;

FIG. 18 is a front view of an electronic device displaying a listing of existing virtual credit cards of the present invention that have been issued by the administrator;

FIG. 19 is a front view of an electronic device displaying an option to block a virtual credit card of the present invention from being used for any future transaction;

FIG. 20 is a front view of an electronic device displaying account details of an existing virtual credit card of the present invention; and

FIG. 21 is a front view of an electronic device displaying options for sending a virtual credit card of the present invention to a recipient;

FIG. 22 is a front view of an electronic device displaying options viewing balance, account settings, instant virtual card settings and virtual credit card setting present invention;

FIG. 23 is a front view of an electronic device displaying options for viewing and changing account settings of the present invention;

FIG. 24 is a front view of an electronic device displaying options for viewing and changing instant virtual credit card settings of the present invention;

FIG. 25 is a front view of an electronic device displaying options for viewing and changing virtual credit card settings of the present invention;

FIG. 26 is a front view of an electronic device displaying a non-editable virtual credit card of the present invention;

FIGS. 27a and 27b are views of a display screen showing a demo mode for demonstrating the method and system of the present invention;

FIGS. 28a-28l are views of a display screen showing steps for securely sending a virtual credit card using the method and system of the present;

FIGS. 29a-29c are views of a display screen showing steps for sending virtual credit cards to multiple recipients at the same time using the method and system of the present invention;

FIG. 30 is a view of a display screen showing steps attaching and sending a photo with a virtual credit card using the method and system of the present invention; and

FIG. 31 is a view of a display screen showing steps for logging into accounts for users having more than one account with the service provider.

### DESCRIPTION OF THE PREFERRED EMBODIMENTS

With reference to FIG. 1, a flow chart showing various users of the method and system of the present invention is illustrated. A credit card issuer 101 provides a line of credit or means to pre-fund an account and account to an account holder 102, who may be a business owner or other individual having a personal account. The account holder 102 may then act as an administrator 103 or appoint another or additional individuals to act as administrators 103, who then manage the account and create and transmit virtual credit cards to recipients 104, such as vendors, employees and so forth, using the method and system of the present invention. Sub-administrators 105 may also manage the account and create and transmit virtual credit cards to recipients 104. Sub-administrators 105 may have narrower access to account information and/or other restrictions on their access to the account, such as only being able to access the account and create virtual credit cards during work hours.

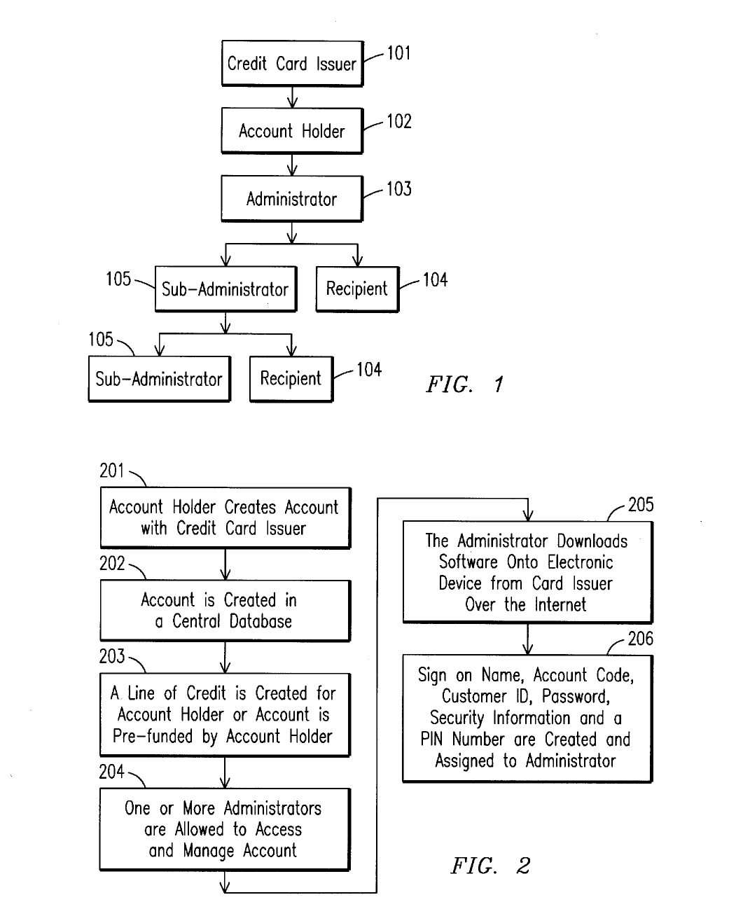

With reference to FIG. 2, a flow chart showing steps for creating an account with a credit card issuer to be used in conjunction with the method and system of the present invention is illustrated. First, an account holder, such as a business owner, creates a credit account or pre-funded account with a credit card issuer 201. Then, the account holder's account information is stored in the card issuer's central database 202. Next, a line of credit is extended to the account holder or the account is pre-funded by the account holder 203 to be used by the account holder to conduct financial transactions using virtual credit cards. Then, the account holder allows one or more administrators or sub-administrators access to the account 204. Next, the one or more administrators or sub-administrators download software from the card issuer onto an electronic device 205 that allows the one or more administrators or sub administrators to create and transmit virtual credit cards using the method and system of the present invention. Finally, a sign on name, account code, customer ID, password, security information and/or personal identification number (“PIN”) are created and assigned to the one or more administrators or sub-administrators 206 to allow them access to the account. In the following description, reference to administrators means administrators and sub-administrators unless otherwise specified.

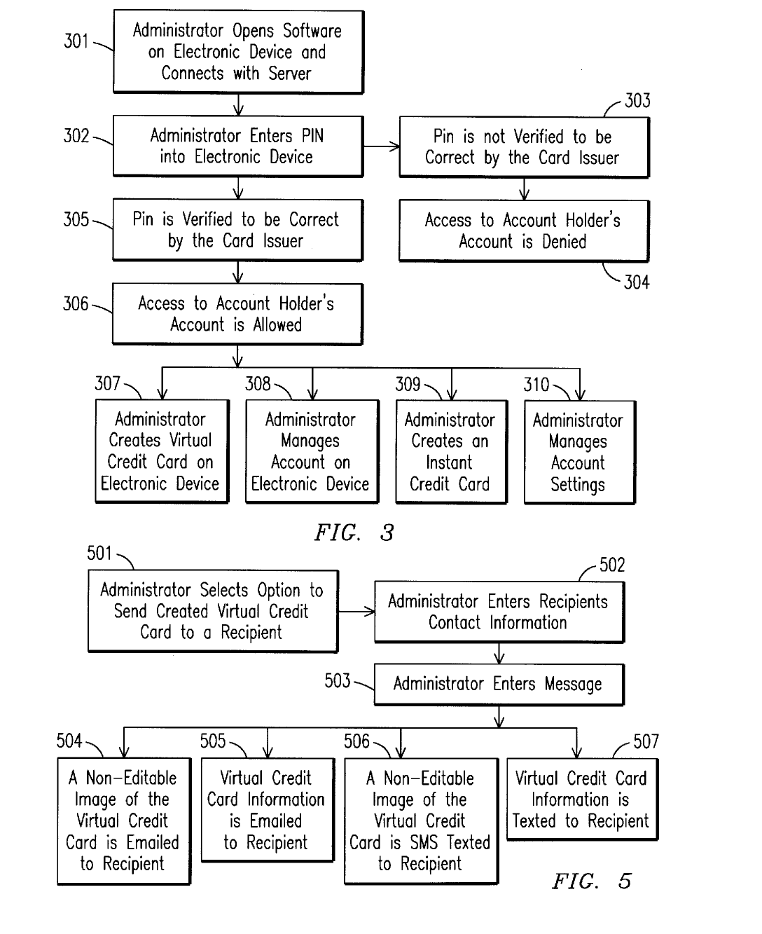

With reference to FIG. 3, a flow chart showing steps for accessing an account holder's account via an electronic device using the method and system of the present invention is illustrated. First, an administrator opens the software on his or her electronic device and is connected with the card issuer's server via the Internet 301. Next, the administrator enters a PIN into the electronic device 302. If the PIN is not verified to be correct by the card issuer 303 then access to the account holder's account is denied 304. If the PIN is verified to be correct by the card issuer 305 then access to the account holder's account is allowed 306. Then, the administrator may create a virtual credit card on the electronic device 307, manage the account on the electronic device 308, create an instant credit card 309 and/or manage account settings 310.

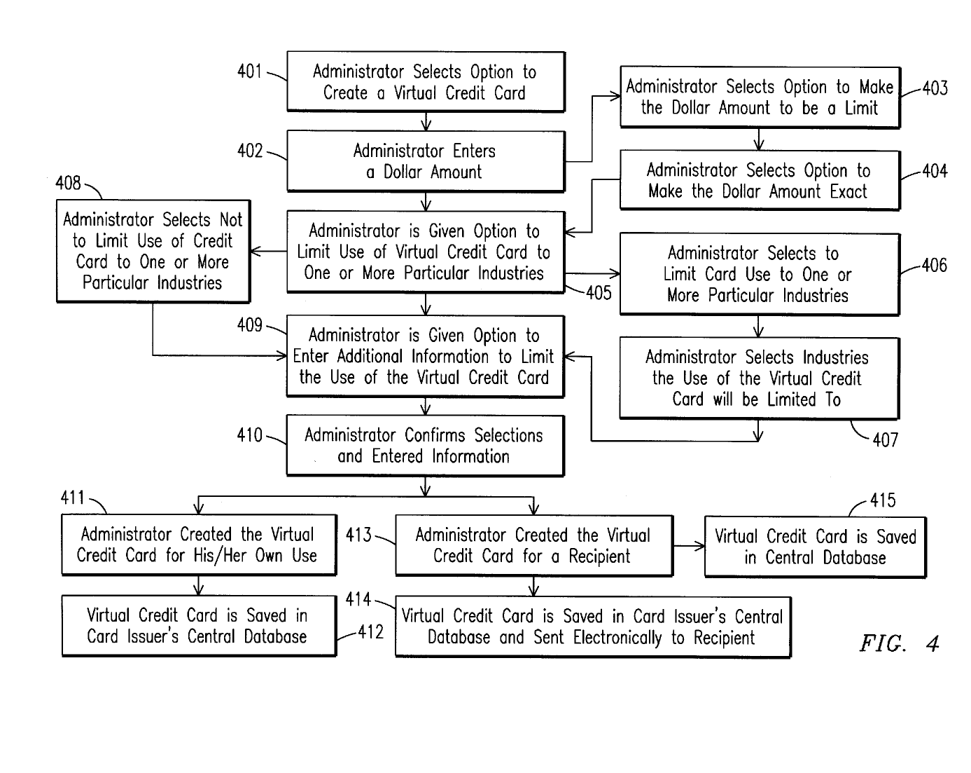

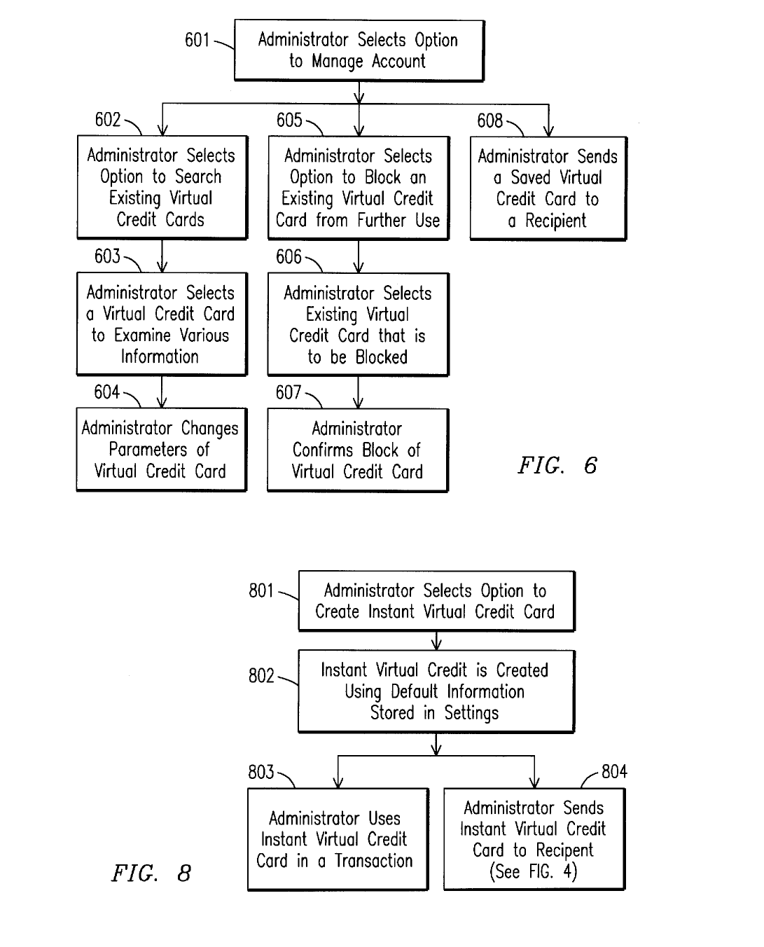

With reference to FIG. 4, a flow chart showing steps for creating a virtual credit card using the method and system of the present invention is illustrated. First, the administrator selects an option to create a virtual credit card 401 (as shown in FIG. 3). Then, the administrator enters a dollar amount 402. Next, the administrator may select an option to make the dollar amount to be a limit 403 that may be charged using the account number that is unique to the virtual credit card being created or the administrator may select an option to make the dollar amount exact 404, thereby limiting the use of the account number and virtual credit card to a specific charge amount. Then, the administrator is given an option to limit use of the virtual credit card to one or more particular industries 405 which may be limited according to merchant category codes (“MCC”). If the administrator selects to limit card use to one or more particular MCC 406 then the administrator selects from a list of industries the use of the virtual credit card will be limited to 407. For example, the virtual credit card may be limited to an MCC for airlines. Alternatively, the administrator may select not to limit use of the virtual credit card to one or more particular MCC 408. Next, the administrator is given an option to enter additional information to limit the use of the virtual credit card 409. Such limitations may include setting an expiration date, limiting the number of transactions the virtual credit card may be used for, limiting the use of the virtual credit card to a specific purchase order or invoice number and so forth. Then, the administrator confirms the selections and entered information 410 and the virtual credit card is created. If the administrator created the virtual credit card for his/her own use 411, then the virtual credit card is saved in the card issuer's central database 412 so the administrator can retrieve the virtual credit card for future use using the electronic device. If the administrator created the virtual credit card for a recipient 413, such as an employee or a vendor, then the virtual credit card is saved in card issuer's central database and sent electronically to the recipient 414 (as illustrated in FIG. 5) or the virtual credit card may be saved in the card issuer's central database 415 to be sent to a recipient at a later date.

With reference to FIG. 5, a flow chart showing steps for electronically transmitting a virtual credit card to a recipient using the method and system of the present invention is illustrated. First, the administrator selects option to send a created virtual credit card to a recipient 501. Then, the administrator enters recipients contact information 502. Next, the administrator may enter a message 503 to accompany the virtual credit card. Then, the administrator may email an un-editable image of the virtual credit card to the recipient 504, email only the virtual credit card information, such as the card number, card security code and so forth, to the recipient 505, SMS text an un-editable image of the virtual credit card to the recipient 506 or text only the virtual credit card information to the recipient 507. If the recipient is a vendor, then the vendor may charge money to the account holder's line of credit according to the limitations placed on the virtual credit card. If the recipient is an employee, then the recipient may use the non-editable image or account number to charge expenses according to the limitations placed on the virtual credit card. The administrator may also have the ability to select a secure and/or tokenized email delivery method, wherein the recipient will receive an email containing a secure link to an online portal accessible via internet browser. After following the link, the recipient will verify their identity, authenticate and log into the online portal to retrieve a virtual credit card.

With reference to FIG. 6, a flow chart showing steps for managing existing virtual credit cards of an account using the method and system of the present invention is illustrated. First, the administrator selects an option to manage the account 601 (as shown in FIG. 3). Then, the administrator may select an option to search existing virtual credit cards 602 have been created and which are saved on the card issuer's central database. Next, the administrator selects a virtual credit card to review 603. Then, the administrator may leave the virtual credit card as is or change certain parameters of the virtual credit card 604, such as expiration date, charge limit, industries wherein the card may be used with and so forth.

The administrator may also select an option to block an existing virtual credit card from further use 605. If the administrator chooses to block an existing virtual credit card form further use, then the administrator selects the existing virtual credit card that is to be blocked 606 from a list of virtual credit cards and the administrator confirms the block of the virtual credit card 607.

The administrator may also select an option to send a saved virtual credit card to a recipient 608.

With reference to FIG. 7, a flow chart showing steps for managing various account settings using the method and system of the present invention is illustrated. First, the administrator selects a settings option 701 (as shown in FIG. 3). Next, the administrator may select an account settings option 702. Then, the administrator is presented with a username 703 and password 704. The administrator may reset the password 705 and/or the administrator may select an option to require the password to be entered prior to creating any virtual credit card 706 as an added security measure. The administrator may also change the PIN 707.

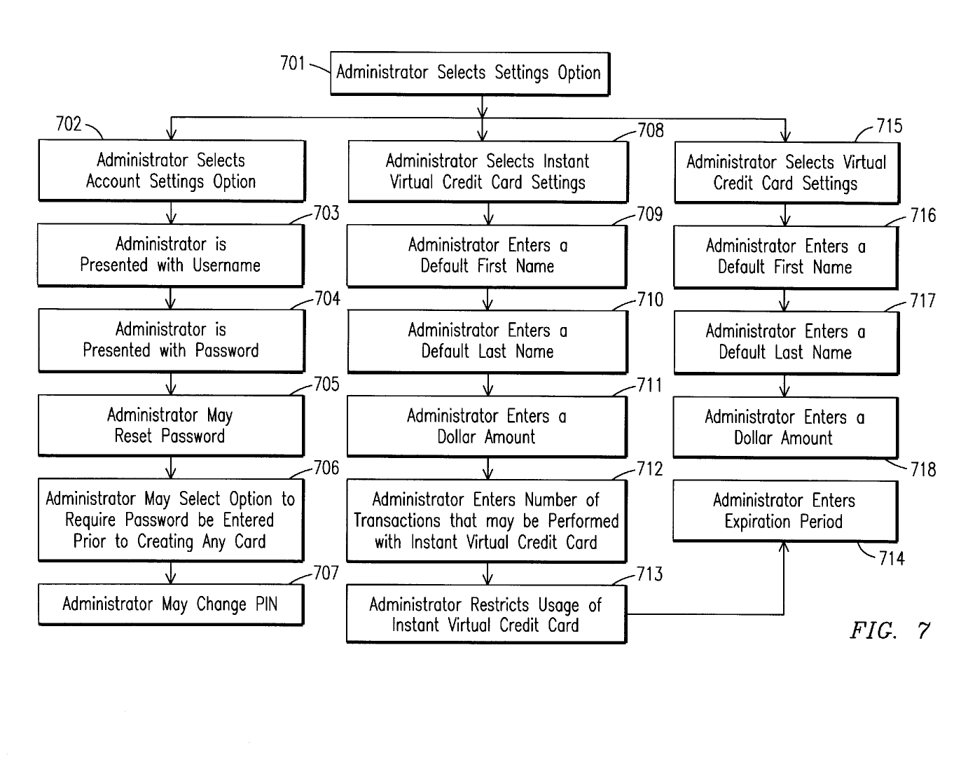

Alternatively, the administrator may select an option to manage instant virtual credit card settings 708. First, the administrator enters a default first name 709. Then, the administrator enters a default last name 710. Next, the administrator enters a dollar amount 711. Then, the administrator may limit the number of transactions that may be performed with the instant virtual credit card 712. Next, the administrator may restrict usage of instant virtual credit card 713, such as limiting the times of day that the instant virtual credit card may be used. Then, the administrator may enter an expiration date 714. Finally, the administrator may use the saved information to create an instant virtual credit card without having to re-enter the information, as illustrated in FIG. 8. The instant virtual credit card is more ideal for situations where the dollar amounts and other factors remain the same and the administrator needs to create an instant virtual credit card on a regular basis, such as creating an instant virtual credit card every month for an employee to pay for office supplies, or for a recurring monthly charges from a vendor.

Alternatively, the administrator may select to manage virtual credit card settings 715, which requires less information than an instant virtual credit card because dollar amounts and other setting are more likely to change than an instant virtual credit card. First, the administrator enters a default first name 716. Then, the administrator enters a default last name 717. Finally, the administrator enters a dollar amount 718. This information will then automatically be populated when the administrator creates a virtual credit card for a recipient, as illustrated in FIG. 4.

With reference to FIG. 8, a flow chart showing steps for creating an instant virtual credit card using the method and system of the present invention is illustrated. First, the administrator selects an option to create an instant virtual credit card 801 and selects a recipient. Then, an instant virtual credit is created using default information stored in the settings 802 for the transaction to be performed or for the recipient selected by the administrator. Next, the administrator uses the instant virtual credit card in a financial transaction 803 or the administrator sends instant virtual credit card to recipient 804 (see FIG. 4).

With reference to FIG. 9, a flow chart showing steps for copying instant virtual credit card information into a payment screen to complete an online purchase using the method and system of the present invention is illustrated. First, an instant virtual credit card is created having a unique credit card number, a card verification code (“CVC”) number and an expiration date 901. Then, an option is selected to copy the credit card number 902 and paste the credit card number into the appropriate field of a payment screen 903. Next, an option is selected to copy the CVC number 904 and paste the CVC number into the appropriate field of a payment screen 905. Then, an option is selected to copy the expiration date 906 and paste the expiration date into the appropriate field of a payment screen 907. Finally, the instant virtual credit card information may be submitted to the online retailer 908, thereby completing the transaction.

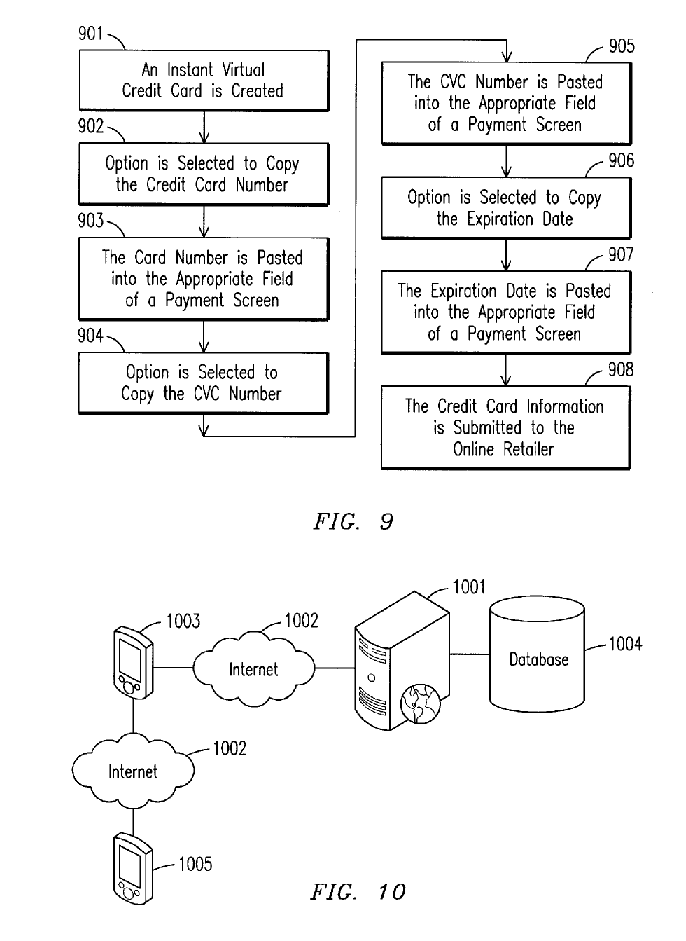

With reference to FIG. 10, an example of a computer environment, in which the method and system of the present invention operates is illustrated. A server 1001 operated by the card issuer receives and sends information over the internet 1002 to an administrator's electronic device 1003. Information regarding the administrator's account and virtual credit cards is stored in the card issuer's central database 1004 and may be accessed and updated by the administrator through the internet 1002 and the card issuer's server 1001. The administrator may create a virtual credit card and then email or text the virtual credit card via the internet 1002 or a mobile system to a recipient's electronic device 1005.

In FIG. 11, a front view of an electronic device displaying an account setup screen of the present invention is illustrated, which is self explanatory when viewed in conjunction with the description of the method and system described herein.

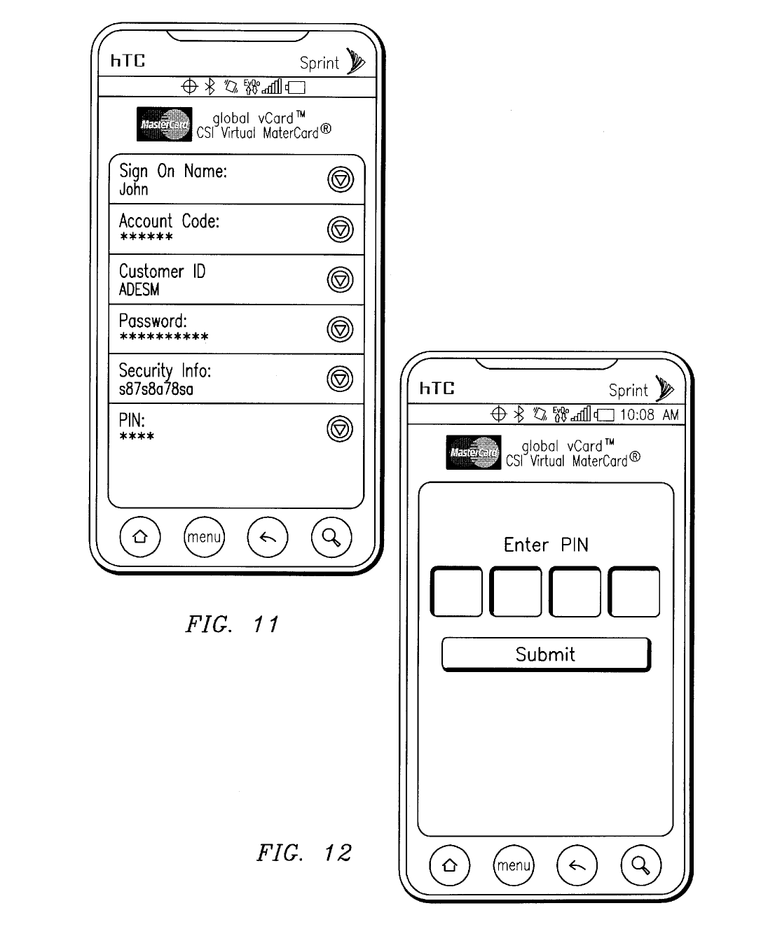

In FIG. 12, a front view of an electronic device displaying a user login screen requiring a PIN of the present invention is illustrated, which is self explanatory when viewed in conjunction with the description of the method and system described herein.

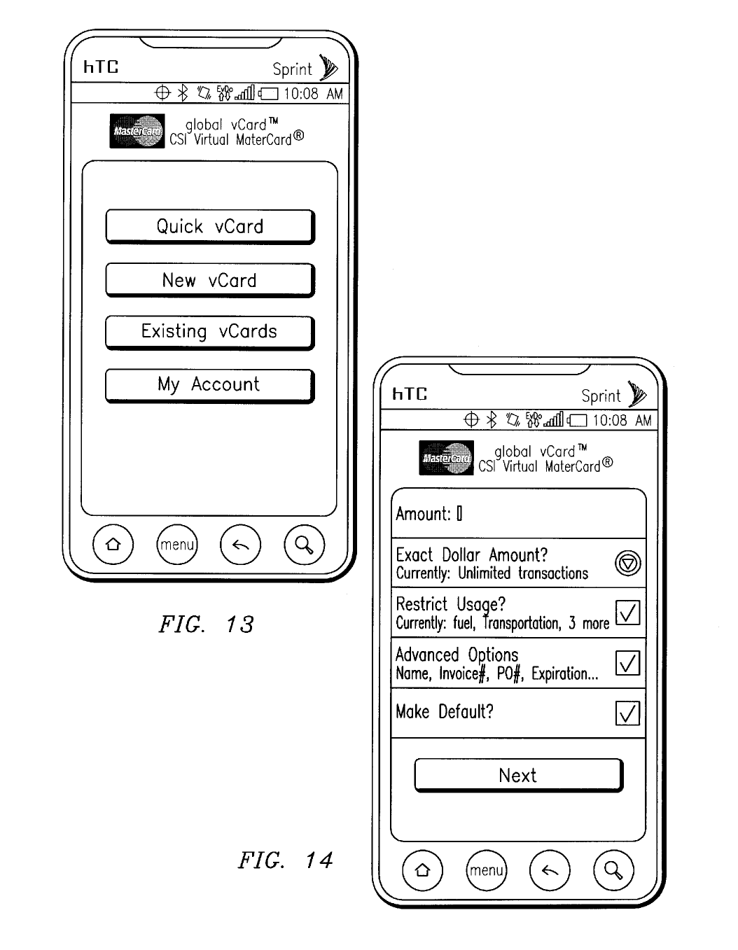

In FIG. 13, a front view of an electronic device displaying a main screen having the options of creating an instant virtual credit card, a virtual credit card, viewing existing virtual credit cards or viewing account settings of the present invention is illustrated, which is self explanatory when viewed in conjunction with the description of the method and system described herein.

In FIG. 14, a front view of an electronic device displaying options and step for creating a virtual credit card of the present invention is illustrated, which is self explanatory when viewed in conjunction with the description of the method and system described herein.

In FIG. 15, a front view of an electronic device displaying advanced options and step for creating a virtual credit card of the present invention is illustrated, which is self explanatory when viewed in conjunction with the description of the method and system described herein.

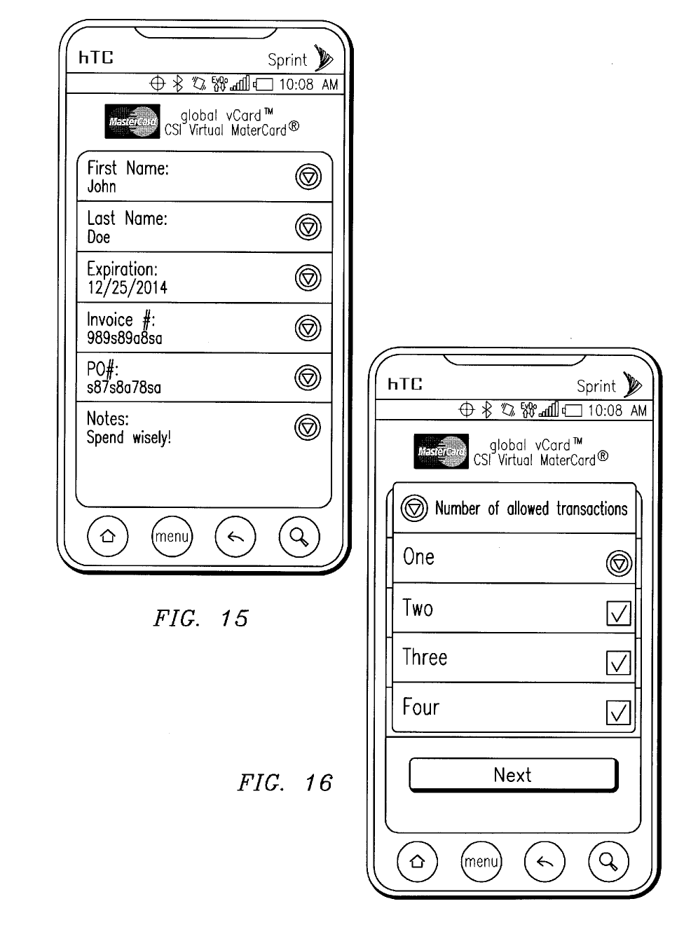

In FIG. 16, a front view of an electronic device displaying an option to limit the number of transactions that may be performed using a virtual credit card of the present invention is illustrated, which is self explanatory when viewed in conjunction with the description of the method and system described herein.

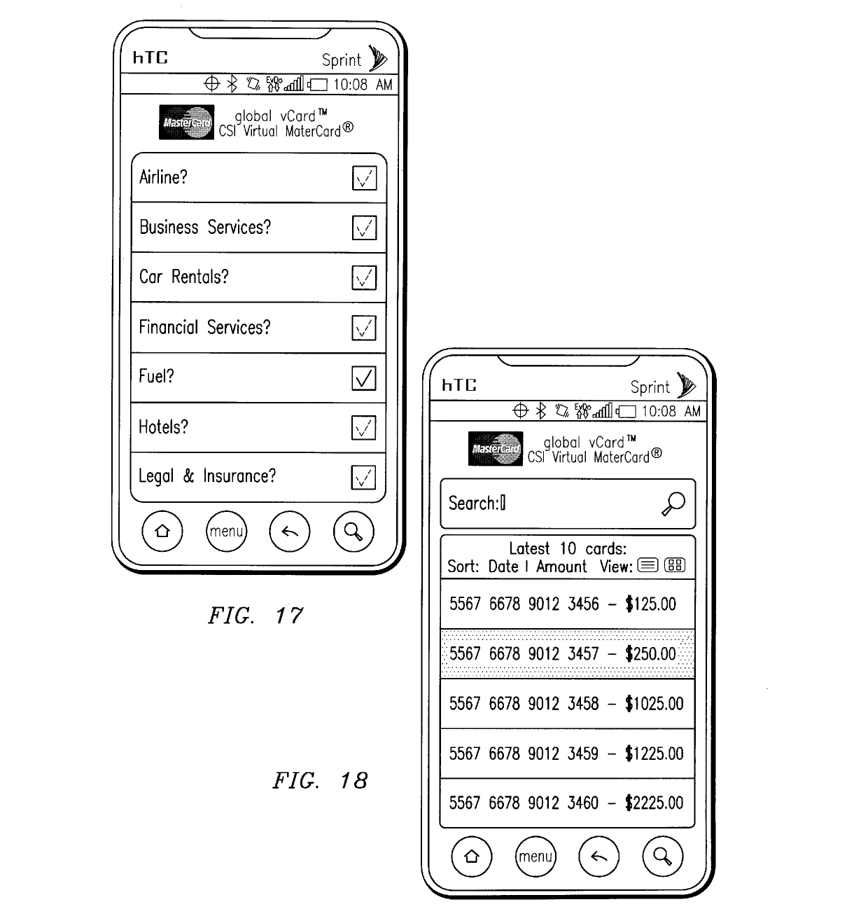

In FIG. 17, a front view of an electronic device displaying an option to limit the merchant categories where a virtual credit card of the present invention may be used is illustrated, which is self explanatory when viewed in conjunction with the description of the method and system described herein.

In FIG. 18, a front view of an electronic device displaying a listing of existing virtual credit cards of the present invention that have been issued by the administrator is illustrated, which is self explanatory when viewed in conjunction with the description of the method and system described herein.

In FIG. 19, a front view of an electronic device displaying an option to block a virtual credit card of the present invention from being used for any future transaction is illustrated, which is self explanatory when viewed in conjunction with the description of the method and system described herein.

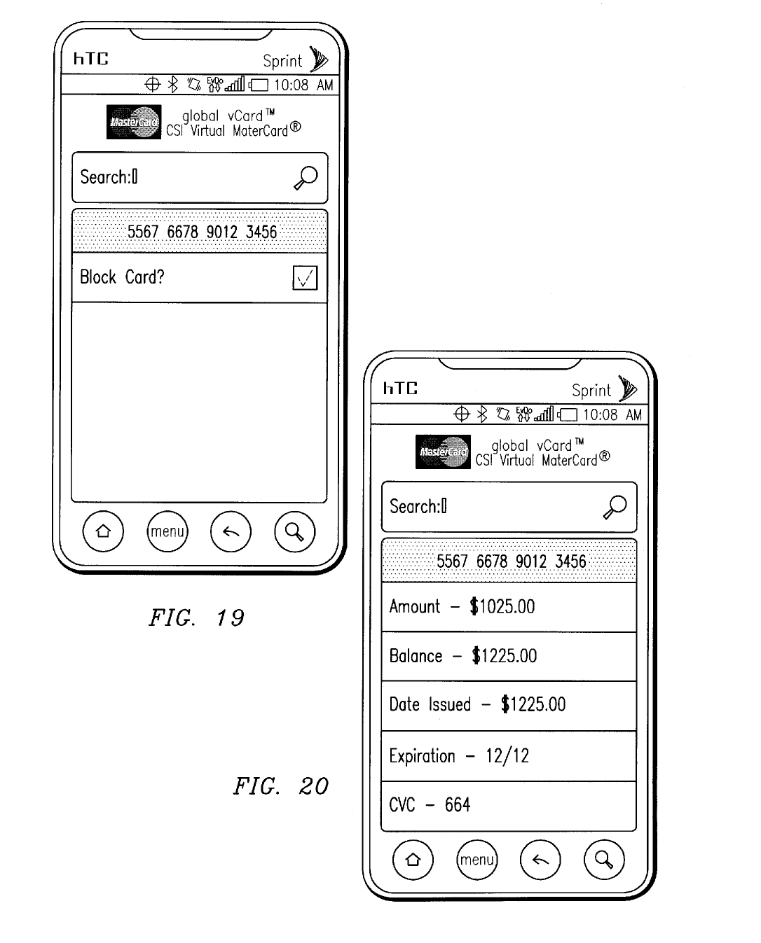

In FIG. 20, a front view of an electronic device displaying account details of an existing virtual credit card of the present invention is illustrated, which is self explanatory when viewed in conjunction with the description of the method and system described herein.

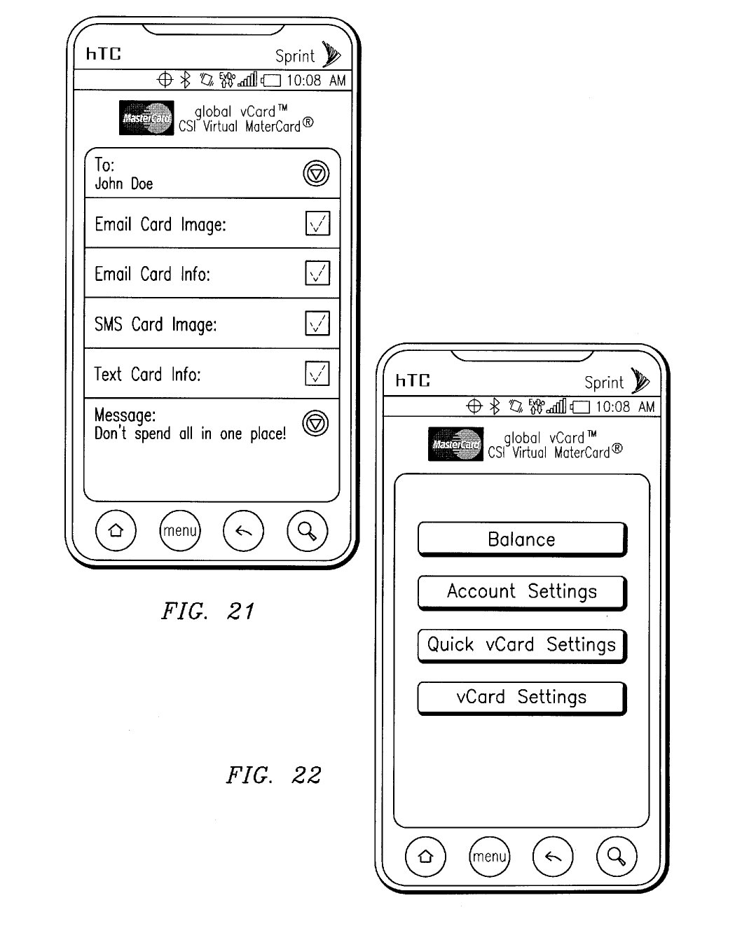

In FIG. 21, a front view of an electronic device displaying options for sending a virtual credit card of the present invention to a recipient is illustrated, which is self explanatory when viewed in conjunction with the description of the method and system described herein.

In FIG. 22, a front view of an electronic device displaying options viewing balance, account settings, instant virtual card settings and virtual credit card setting present invention is illustrated, which is self explanatory when viewed in conjunction with the description of the method and system described herein.

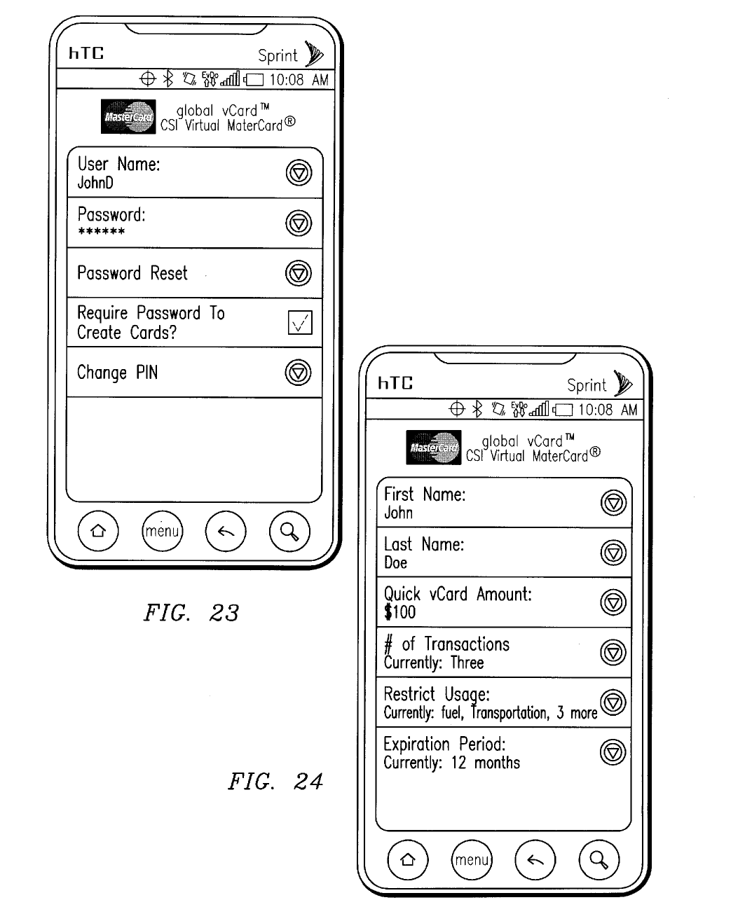

In FIG. 23, a front view of an electronic device displaying options for viewing and changing account settings of the present invention is illustrated, which is self explanatory when viewed in conjunction with the description of the method and system described herein.

In FIG. 24, a front view of an electronic device displaying options for viewing and changing instant virtual credit card settings of the present invention is illustrated, which is self explanatory when viewed in conjunction with the description of the method and system described herein.

In FIG. 25, a front view of an electronic device displaying options for viewing and changing virtual credit card settings of the present invention is illustrated, which is self explanatory when viewed in conjunction with the description of the method and system described herein.

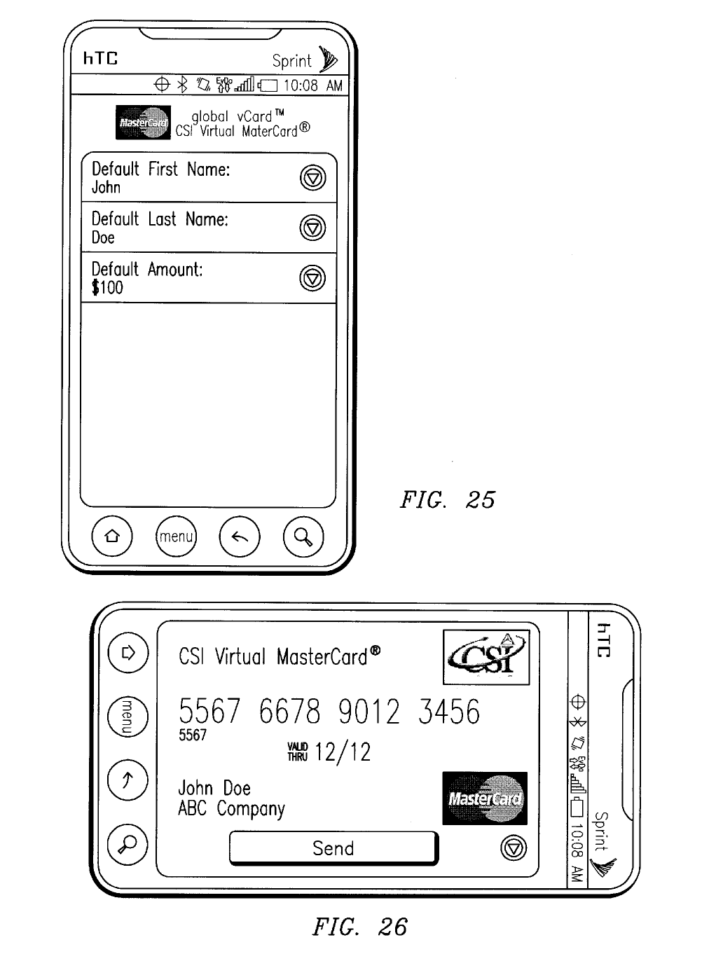

In FIG. 26, a front view of an electronic device displaying a non-editable virtual credit card of the present invention is illustrated, which is self explanatory when viewed in conjunction with the description of the method and system described herein.

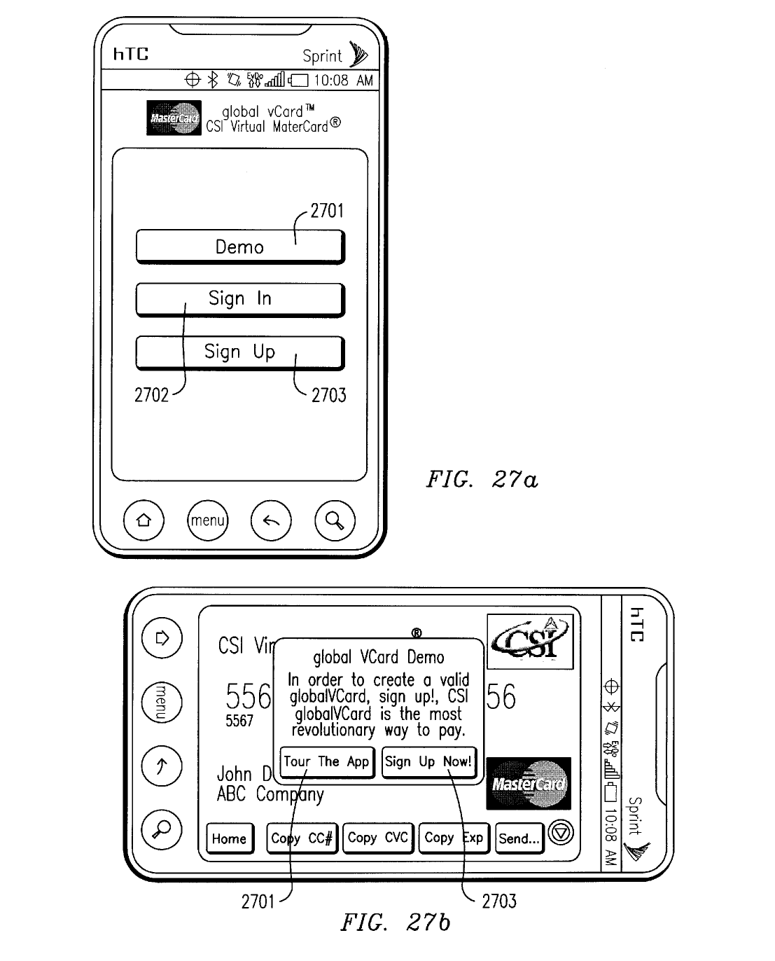

With regard to FIGS. 27a and 27b, views of a display screen showing a demo mode for demonstrating the method and system of the present invention are illustrated. After a user first downloads the service provider's software on his or her electronic device, the user is given three options, as illustrated in FIG. 27a. The user may watch a demo explaining how the software works 2701, as illustrated in FIG. 27b, sign into an existing account with the service provider 2702 or create a new account with the service provider 2703.

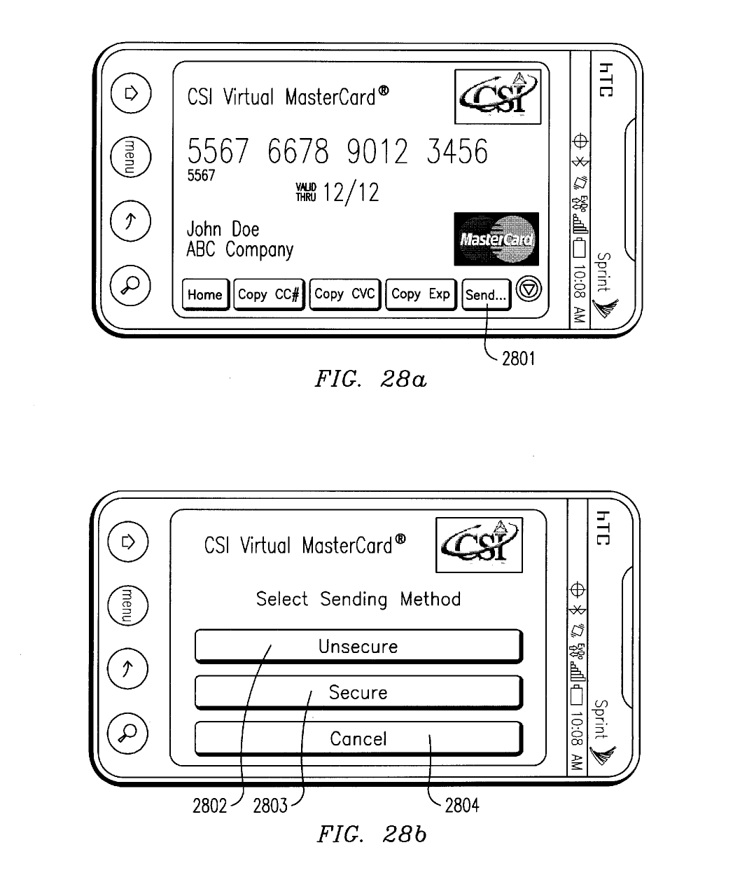

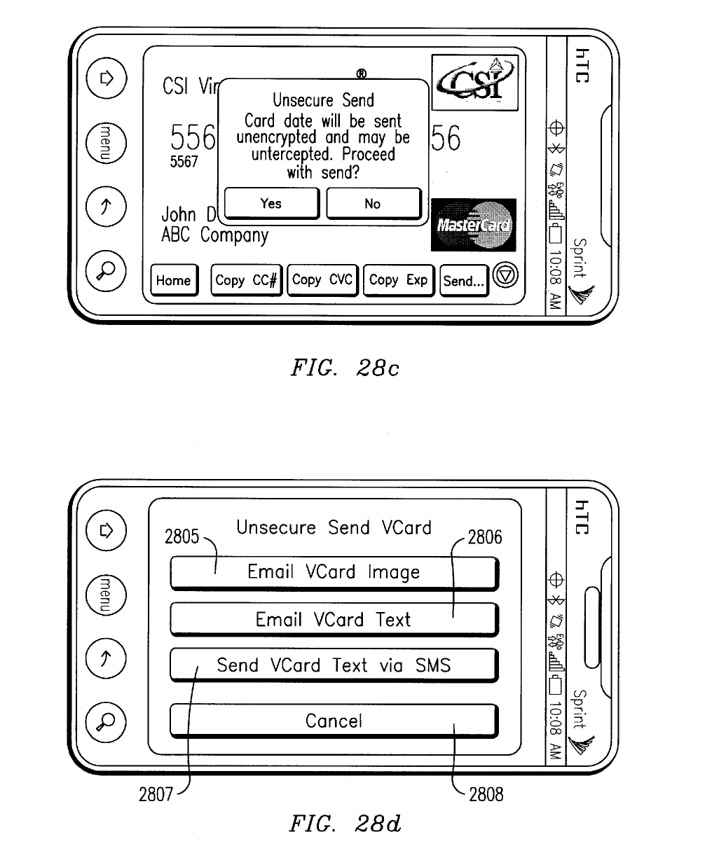

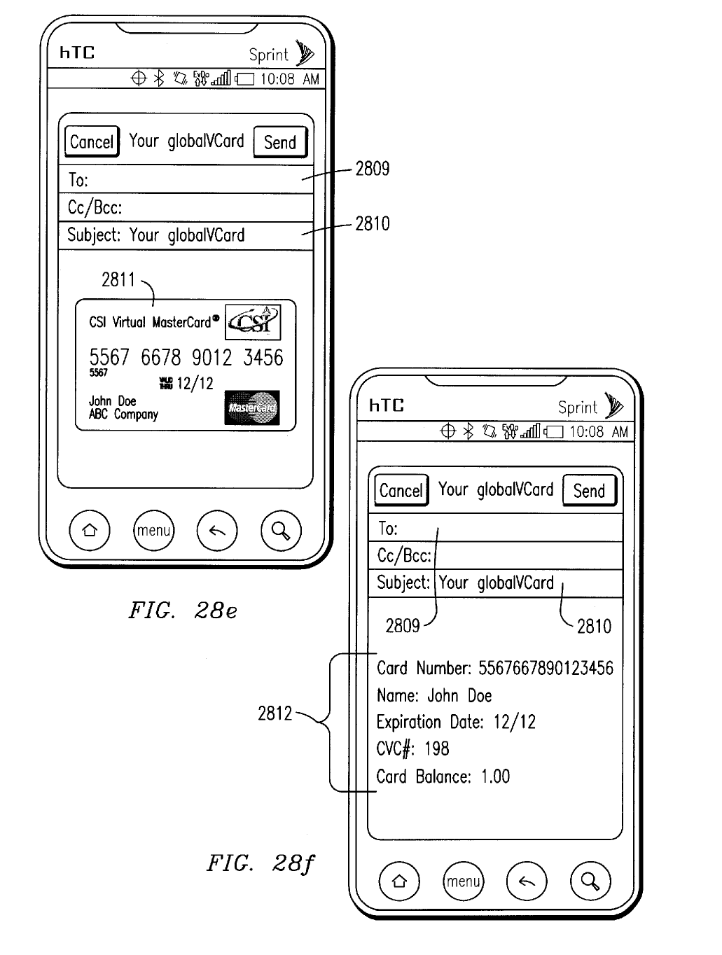

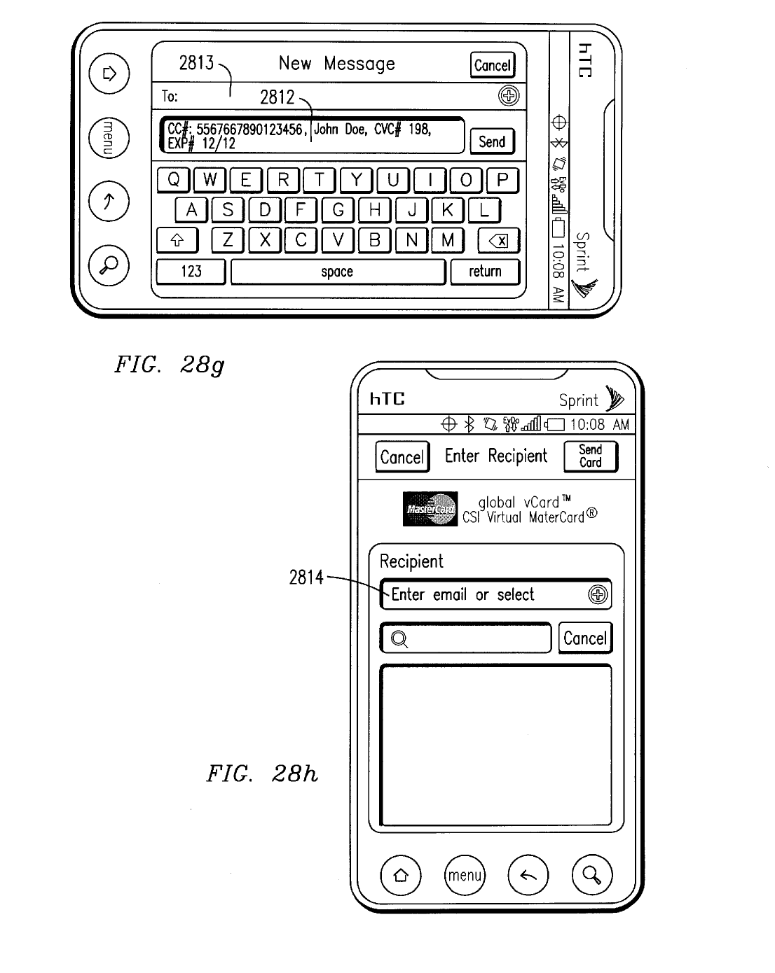

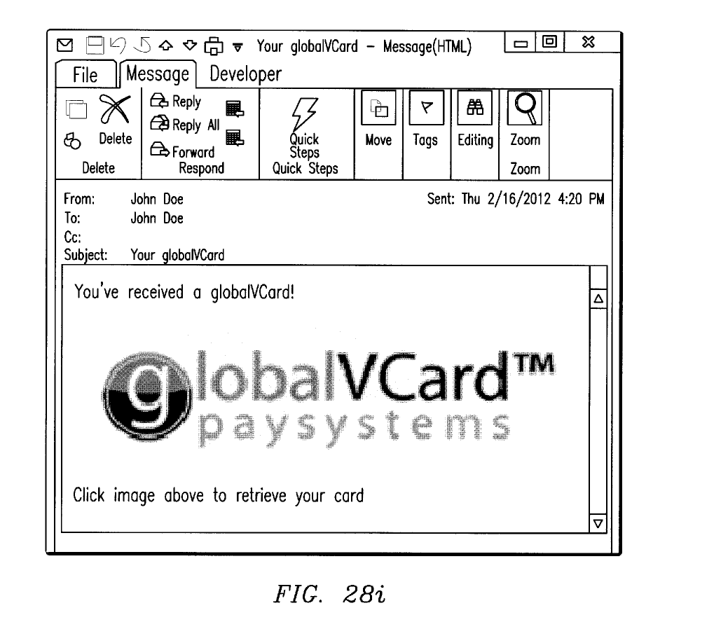

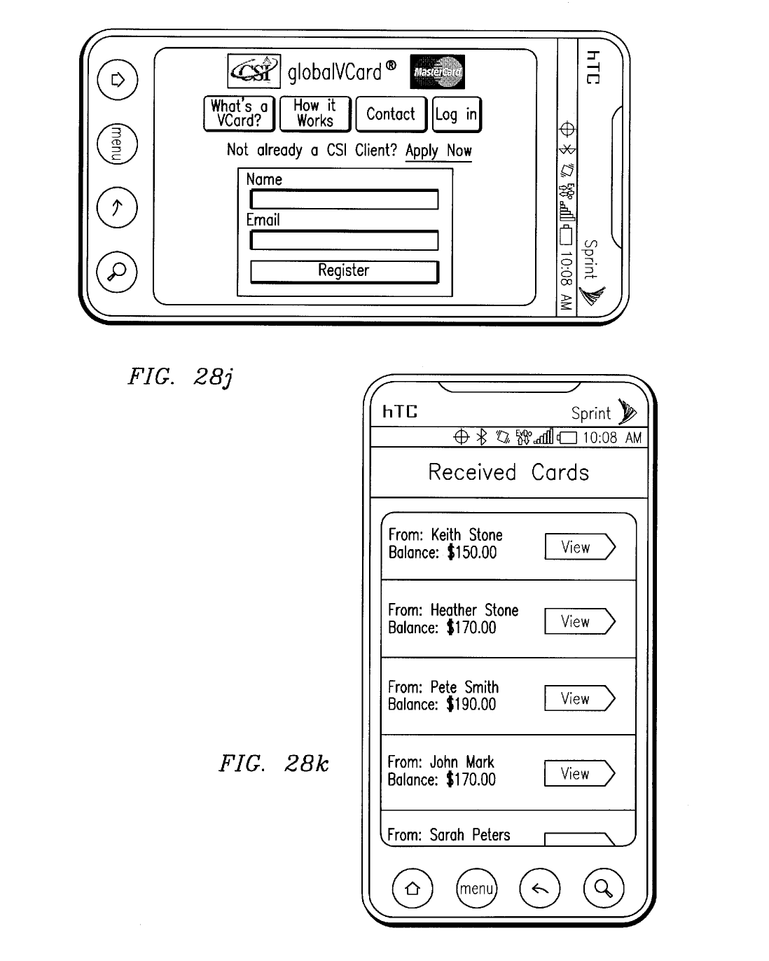

With regard to FIGS. 28a-28l, views of a display screen showing steps for securely sending a virtual credit card using the method and system of the present invention are illustrated. First, a user or administrator creates a virtual credit card and chooses an option to send 2801 the virtual credit card to a recipient, as illustrated in FIG. 28a. Then, the user is given the options of sending the virtual credit card as an unsecure transmission 2802, as a secure transmission 2803 or to cancel the send 2804, as illustrated in FIG. 28b. If the user chooses to send the virtual credit card as an unsecure transmission 2802, then the user will be required to confirm the decision, as illustrated in FIG. 28c. The user is then given the options to send the virtual credit card as an image via email 2805, as text via email 2806, as text via SMS 2807 or to cancel the virtual credit card 2808, as illustrated in FIG. 28d. If the user chooses to send the virtual credit card as an image via email 2805, then the user will be allowed to enter the recipients email address 2809, a subject to the email 2810, and a message. An image of the card 2811 will be shown in the body of the email, as illustrated in FIG. 28e. If the user chooses to send the virtual credit card as text via email 2806, then the user will be allowed to enter the recipients email address 2809, a subject to the email 2810, and a message. A text version of the virtual credit card 2812 will be shown in the body of the email, as illustrated in FIG. 28f. If the user chooses to send the virtual credit card as text via SMS 2806, then the user will be allowed to enter the recipients phone number 2813 and a message. A text version of the virtual credit card 2812 will be shown in the body of the SMS, as illustrated in FIG. 28g. If the user chose to send the virtual credit card as a secure transmission 2803, then the user will be allowed to enter the recipients contact information 2814, as illustrated in FIG. 28h. The recipient will then be sent a message informing him or her that they have been issued a virtual credit card and directing him or her to a website to retrieve the virtual credit card, as illustrated in FIG. 28i. When the recipient visits the website, he or she is allowed to login using a pre-existing username and website or allowed to create a new account to securely login to retrieve the virtual credit card, as illustrated in FIG. 28j. The recipient's account may be limited to only allow the recipient to view received cards, as illustrated in FIGS. 28k and 28l. The account may also be limited in other manners, such as limiting sub-users or sub-administrator to only views cards they have personally created.

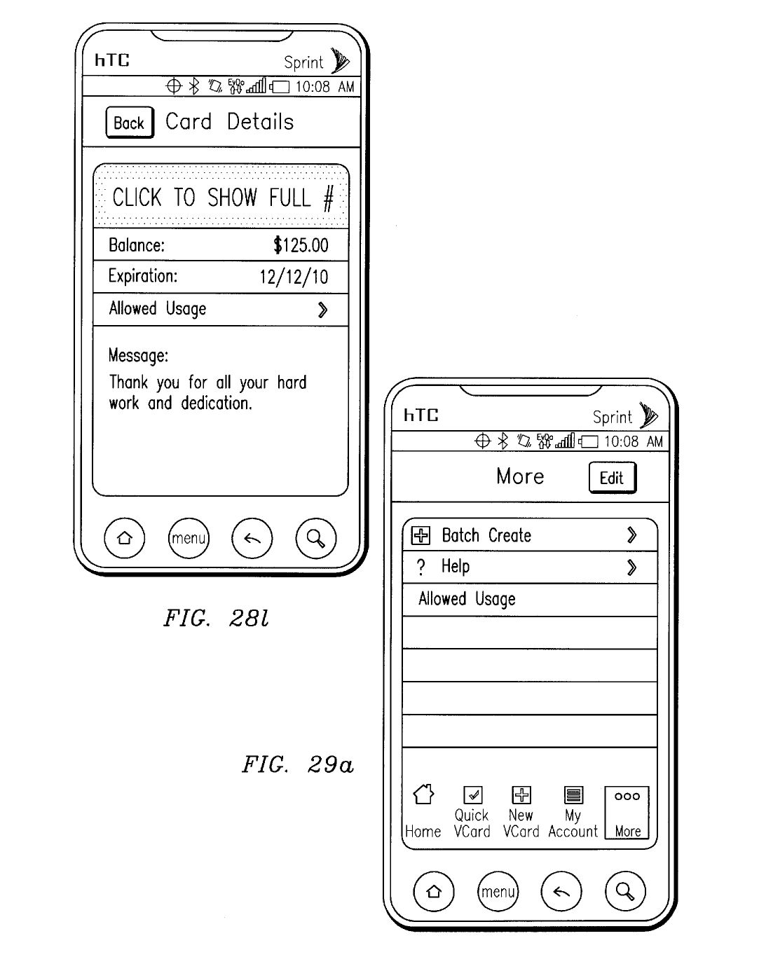

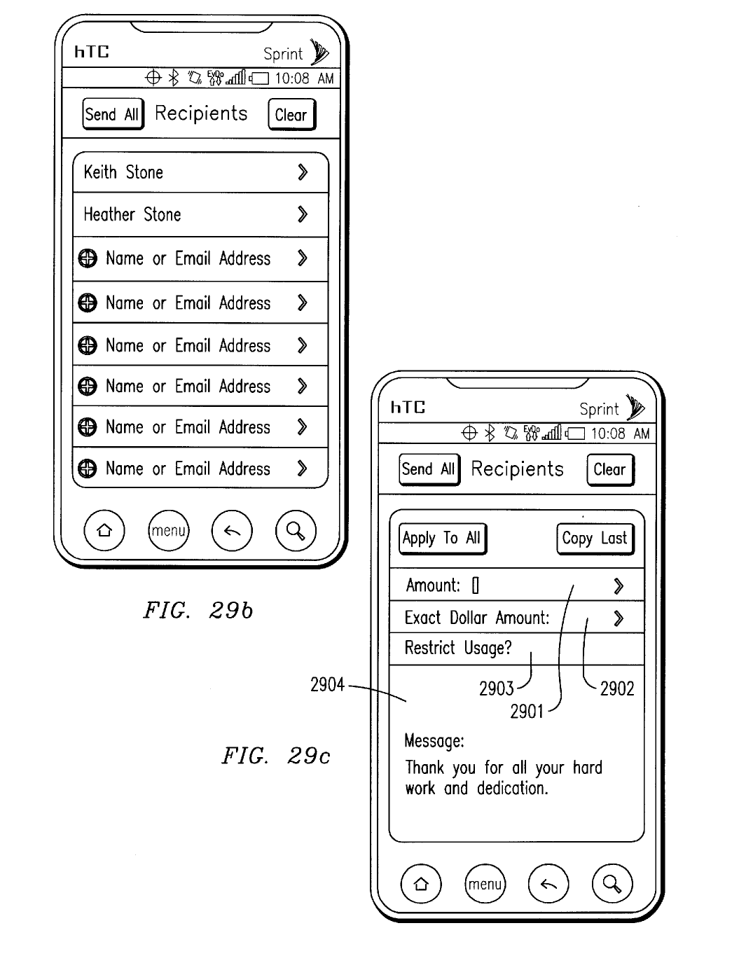

With regard to FIGS. 29a-29c, views of a display screen showing steps for sending virtual credit cards to multiple recipients at the same time using the method and system of the present invention are illustrated. First, a user selects an option to create a mailing list of recipients, as illustrated in FIG. 29a. Then, the user enters each recipient's contact information either manually or by importing from a pre-populated contact list on the electronic device, which may be an email address or telephone number, as illustrated in FIG. 29b. Finally, the user may enter a dollar amount 2901, an exact dollar amount 2902, restrict usage of the virtual credit card 2903 and/or enter a message 2904, as illustrated in FIG. 29c.

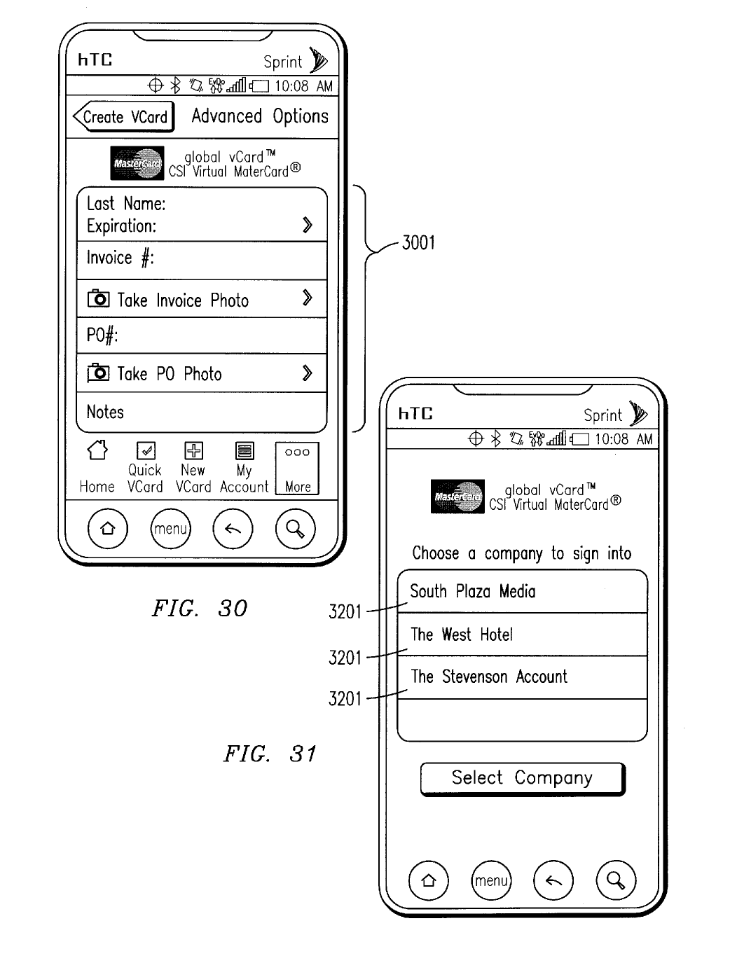

With regard to FIG. 30, a view of a display screen showing steps attaching and sending a photo with a virtual credit card using the method and system of the present invention is illustrated. A user may attach a photo of purchase order, invoice and so forth to an email or SMS 3001 so the recipient knows what to apply the payment to.

Finally with regard to FIG. 31, a view of a display screen showing steps for logging into accounts for users having more than one account with the service provider is illustrated. Users having more than one account 3201 for different businesses may select the appropriate account when creating a virtual credit card or checking existing virtual credit cards.

It is to be understood that while a preferred embodiment of the invention is illustrated, it is not to be limited to the specific form or arrangement of parts herein described and shown. It will be apparent to those skilled in the art that various changes may be made without departing from the scope of the invention and the invention is not to be considered limited to what is shown and described in the specification and drawings.

Having thus described my invention, I claim:

1. A method for account holders to make, track and control virtual credit card numbers using an electronic device, said method comprising the steps of:
a. an account holder creating an account with a credit card issuer;
b. at least one administrator being allowed access to manage the account and issue virtual credit cards to recipients;
c. the at least one administrator downloading software onto an electronic device that allows the administrator to access a server and database controlled by the credit card issuer;
d. said at least one administrator being assigned a sign on name and password to access; and
e. said administrator creating a virtual credit card.

2. The method of claim 1 further comprising a step after step e of:
said at least one administrator emailing the virtual credit card to a recipient.

3. The method of claim 2 wherein:
said virtual credit card is a non-editable image of a credit card that the recipient can display on a screen of an electronic device.

4. The method of claim 1 further comprising a step after step e of:
said at least one administrator texting the virtual credit card to a recipient.

5. The method of claim 4 wherein:
said virtual credit card is a non-editable image of a credit card that the recipient can display on a screen of an electronic device.

6. The method of claim 1 wherein:
said password is a personal identification number.

7. The method of claim 1 further comprising the step of:
said at least on administrator limiting the virtual credit card to only be used to conduct financial transactions at merchants having selected merchant category codes.

8. The method of claim 1 further comprising the step of:
said at least on administrator limiting the number or financial transactions the virtual credit card may be used to conduct.

9. The method of claim 1 further comprising the step of:
the account holder being extended a line of credit to fund the account.

10. The method of claim 1 further comprising the step of:
the account being pre-funded by the account holder.

11. The method of claim 1 wherein:
said electronic device is a smart phone.

12. The method of claim 1 wherein:
said electronic device is a tablet.

13. The method of claim 1 wherein:
said electronic device is a computer.

14. The method of claim 1 further comprising a step after step e of:
said at least one administrator blocking the virtual credit card form further use.

15. The method of claim 1 further a comprising a step of:
said at least one sub-administrator being appointed to manage the account.

16. The method of claim 15 further a comprising a step of:
said at least one administrator limiting the at least one sub-administrator's access to the account.

17. The method of claim 1 further a comprising a step of:
entering and storing information into account that may be later used to create an instant virtual credit card.

18. The method of claim 1 further comprising a step of:
copying a credit card number from a virtual credit card in an electronic device; and
pasting the credit card number into a field of a payment screen.

19. The method of claim 1 further comprising a step of:
requiring a recipient of a virtual credit card to enter into a secure website to retrieve the virtual credit card.

20. The method of claim 1 further comprising a step of:
a plurality of virtual credit cards are created and transmitted simultaneously to a plurality of recipients.

21. The method of claim 2 further comprising a step of:
attaching a photo to the email.

22. The method of claim 4 further comprising a step of:
attaching a photo to the text.

23. A system for account holders to make, track and control virtual credit card numbers using an electronic device, said system comprising:
an account holder creating an account with a credit card issuer;
at least one administrator being allowed access to manage the account and issue virtual credit cards to recipients;
the at least one administrator downloading software onto an electronic device that allows the administrator to access a server and database controlled by the credit card issuer;
said at least one administrator being assigned a sign on name and password to access; and
said administrator creating a virtual credit card.

24. The system of claim 23 further comprising:
said at least one administrator emailing the virtual credit card to a recipient.

25. The system of claim 24 wherein:
said virtual credit card is a non-editable image of a credit card that the recipient can display on a screen of an electronic device.

26. The system of claim 23 further comprising:
said at least one administrator texting the virtual credit card to a recipient.

27. The system of claim 26 wherein:
said virtual credit card is a non-editable image of a credit card that the recipient can display on a screen of an electronic device.

28. The system of claim 23 wherein:
said password is a personal identification number.

29. The system of claim 23 further comprising:
said at least on administrator limiting the virtual credit card to only be used to conduct financial transactions at merchants having selected merchant category codes.

30. The system of claim 23 further comprising:
said at least on administrator limiting the number or financial transactions the virtual credit card may be used to conduct.

31. The system of claim 23 further comprising:
the account holder being extended a line of credit to fund the account.

32. The system of claim 23 further comprising:
the account being pre-funded by the account holder.

33. The system of claim 23 wherein:
said electronic device is a smart phone.

34. The system of claim 23 wherein:
said electronic device is a tablet.

35. The system of claim 23 wherein:
said electronic device is a computer.

36. The system of claim 23 further comprising:
said at least one administrator blocking the virtual credit card form further use.

37. The system of claim 23 further a comprising:
said at least one sub-administrator being appointed to manage the account.

38. The system of claim 37 further a comprising:
said at least one administrator limiting the at least one sub-administrator's access to the account.

39. The system of claim 23 further a comprising:
entering and storing information into account that may be later used to create an instant virtual credit card.

40. The system of claim 23 further comprising:
copying a credit card number from a virtual credit card in an electronic device; and
pasting the credit card number into a field of a payment screen.

41. The method of claim 23 further comprising a step of:
requiring a recipient of a virtual credit card to enter into a secure website to retrieve the virtual credit card.

42. The method of claim 23 further comprising a step of:
a plurality of virtual credit cards are created and transmitted simultaneously to a plurality of recipients.

43. The method of claim 24 further comprising a step of:
attaching a photo to the email.

44. The method of claim 26 further comprising a step of:
attaching a photo to the text.
